(19) United States
(12) Patent Application Publication
(10) Pub. No.: US 2020/0315318 A1
(43) Pub. Date: Oct. 8, 2020

(54) COMPACT CONTAINER HAVING MIXING CUSHION AND MIXING MESH

(71) Applicant: PUM-TECH KOREA CO., LTD, Incheon (KR)

(72) Inventor: Do Hoon LEE, Incheon (KR)

(21) Appl. No.: 16/305,822

(22) PCT Filed: Jun. 26, 2017
(86) PCT No.: PCT/KR2017/006698

§ 371 Date: Nov. 29, 2018

(30) Foreign Application Priority Data
Jun. 27, 2016 (KR) 10-2016-0080097

(51) Int. Cl. A45D 40/22; A45D 34/00; A45D 40/26; B05B 11/00

(52) U.S. Cl. CPC A45D 40/22; A45D 34/00; A45D 40/26; B05B 11/3069; A45D 2200/054; B05B 11/00416; B05B 11/0044; B05B 11/0038

(57) ABSTRACT

The present invention relates to a compact container having a mixing cushion and a mixing mesh, and the compact container comprising: a discharge means installed in an upper part of an inner container for receiving a cosmetic material; a distribution plate and a discharge plate, both coupled to an upper part of the discharge means; a mixing cushion formed on an upper surface of the discharge plate; and a mixing mesh formed to surround an upper surface of the mixing cushion, wherein, when the mixing mesh is pressed by a puff, the cosmetic material is discharged by the discharge means to be uniformly mixed while being absorbed into the mixing cushion, and is then discharged through the mixing mesh to uniformly smear the entire lower surface of the puff. Therefore, the compact container enables a user to easily use a uniformly mixed cosmetic material.

### CROSS-REFERENCE TO RELATED APPLICATIONS

This application is based on and claims the benefit of priority to Korean Patent Application No. 10-2016-0080097 filed on Jun. 27, 2016, with the Korean Intellectual Property Office, the disclosure of which is incorporated herein by reference.

### TECHNICAL FIELD

The present invention relates to a compact container having a mixing cushion and a mixing mesh, and more specifically, to a compact container having a mixing cushion and a mixing mesh, the compact container comprising: a discharge means installed in an upper part of an inner container for receiving a cosmetic material; a distribution plate and a discharge plate, both coupled to an upper part of the discharge means; a mixing cushion formed on an upper surface of the discharge plate; and a mixing mesh formed to surround an upper surface of the mixing cushion, wherein, when the mixing mesh is pressed by a puff, the cosmetic material is discharged by the discharge means to be uniformly mixed while being absorbed into the mixing cushion, and is then discharged through the mixing mesh to uniformly smear the entire lower surface of the puff. Therefore, the compact container enables a user to easily use a uniformly mixed cosmetic material.

### BACKGROUND ART

In general, cosmetics are used mainly for women to make their appearance beautiful, and there are various kinds of cosmetics according to a function and a form.

The cosmetics are classified into base makeup cosmetics and point makeup cosmetics used for eyes, eyebrows, lips, or the like. The base makeup cosmetics include a foundation and a blusher, and the point makeup cosmetics include an eye shadow, a mascara, an eye-liner, and a lipstick.

The foundation is classified into solid type foundation, liquid type foundation and gel type foundation according to a type of cosmetic contents. In case of the solid type foundation, although the solid-type foundation has a good cover effect, the makeup is united when the makeup is refreshed. In case of the liquid type foundation, although the liquid type foundation gives a good close contact feel, the persistency is weak.

Thus, recently, the number of customers who prefer the gel type foundation, which provides a freshness with lightness and moisture, has been increased.

However, when the gel type foundation is used after filled in the conventional container, it is difficult to use the same amount of a cosmetic material for every makeup, and the cosmetic material is contaminated with bacteria and wastes due to repeated contacts on the cosmetic material by a hand of a user or a puff.

To solve the problem, as shown in FIG. 1, Korean Patent Registration No. 10-1566114 has been disclosed a cosmetic container. According to the related art, the cosmetic container includes a discharge means for discharging a cosmetic material to the outside; and a discharge plate provided on one side of the discharge means from which the cosmetic material is discharged, formed with at least one outlet, and exposed to the outside to come into contact with the user's puff, wherein the cosmetic material is discharged from the discharge means by pressing the discharge plate.

However, according to the conventional cosmetic container, when the discharged cosmetic material is puffed to makeup, the cosmetic material is not uniformly applied to a lower surface of the puff as a whole, but partially applied to the lower surface of the puff, and thus it is difficult to uniformly spread the cosmetic material on a skin.

To solve the above problem, as shown in FIG. 2, the applicant of the present invention has filed an application for a compact container with Korean Utility Model Registration No. 20-0470757, in which an airless pump is installed inside the conventional compact container, and a mixing member 1 is provided at an upper end of the airless pump, so that a cosmetic material discharged in a fixed amount by the airless pump is uniformly mixed by the mixing member 1.

However, according to the conventional compact container, since the mixing member 1 is installed and fixed on an upper portion of the distribution member 2, and the distribution member 2 is fixed to an upper portion of the airless pump, only the mixing member 1 cannot be replaced when the mixing member 1 is contaminated, and thus the entire compact container is required to be replaced, thereby wasting resources and causing an economic burden to the user.

### DISCLOSURE

### Technical Problem

To solve the above problems, the present invention provides a compact container having a mixing cushion and a mixing mesh, in which a discharge device is installed on an upper portion of the inner container for containing a cosmetic material, and a discharge plate and a distribution plate are coupled to an upper portion of the discharge device, wherein a mixing cushion is provided on an upper surface of the discharge plate, a mixing mesh is provided to surround an upper surface of the mixing cushion, and thus, when the mixing mesh is pressed by a puff, the cosmetic material discharged by the discharge device is absorbed into the mixing cushion, uniformly mixed, discharged through the mixing mesh, and then uniformly applied onto an entire lower surface of the puff, so that the user easily uses the uniformly mixed cosmetic material.

In addition, the present invention provides a compact container having a mixing cushion and a mixing mesh, in which the mixing mesh configured to be joined to the inside of the ring-shaped fixture, and the ring-shaped fixture is configured to fix the mixing cushion and be detached from or attached to the distribution plate or the discharge plate, so that the mixing cushion is conveniently replaced simply by separating the ring-shaped fixture from the distribution plate when the mixing cushion is contaminated.

### Technical Solution

The present invention provides a compact container having a mixing cushion and a mixing mesh, which includes: an inner container (10) for containing a cosmetic material therein;

a discharge device (20) for discharging the cosmetic material contained in the inner container (10);

a distribution plate (30) for diffusing the cosmetic material discharged by the discharge device (20);

a discharge plate (40) for discharging the cosmetic material diffused by the distribution plate (30) through an outlet (42);
a mixing cushion (50) provided on the discharge plate (40) to uniformly mix the cosmetic material; and a ring-shaped fixture (60) detachably coupled to the distribution plate (30) or the discharge plate (40) while surrounding the mixing cushion (50), and provided at a center thereof with a mixing mesh (66).

In addition, the inner container (10) is coupled at an outer side thereof with an outer container (80) and an outer container lid (90) for opening/closing the outer container (80).

In addition, the discharge device (20) is provided at an outer periphery of a pump housing (21) thereof with an inner container coupling shoulder (17), and the inner container coupling shoulder (17) has one side coupled to a shoulder lid (70) for opening and closing the inner container coupling shoulder (17).

In addition, the discharge device (20) may be a pump for pumping and discharging the cosmetic material to the outside.

In addition, the discharge plate (40) may be formed on an upper surface thereof with a movement preventing protrusion wheel (44) for preventing the mixing cushion (50) from moving.

In addition, the mixing cushion (50) may be formed of at least one material selected from the group including butadiene rubber (BR), styrene butadiene rubber (SBR), natural rubber (NR), wet urethane, dry urethane, polyether, polyester, polyvinyl chloride, polyethylene, ethylene vinyl acetate, latex, silicone, polystyrene polyisoprene polystyrene, polystyrene polyethylene butylene polystyrene, polyvinyl alcohol (PVA), silicone elastomer, nitrile rubber, butyl rubber, and neoprene.

In addition, the ring-shaped fixture (60) includes a coupling part (62) detachably coupled to the distribution plate (30) or the discharge plate (40), and a joining part (64) extending inside the coupling part (62) and joined to the mixing mesh (66).

### Advantageous Effects

According to the compact container having the mixing cushion and the mixing mesh of the present invention, a discharge device is installed on an upper portion of the inner container for containing a cosmetic material, and a discharge plate and a distribution plate are coupled to an upper portion of the discharge device, in which a mixing cushion is provided on an upper surface of the discharge plate, a mixing mesh is provided to surround an upper surface of the mixing cushion, and thus, when the mixing mesh is pressed by a puff, the cosmetic material discharged by the discharge device is absorbed into the mixing cushion, uniformly mixed, discharged through the mixing mesh, and then uniformly applied onto an entire lower surface of the puff, so that the user can easily use the uniformly mixed cosmetic material.

In addition, according to the compact container having the mixing cushion and the mixing mesh of the present invention, the mixing mesh is configured to be joined to the inside of the ring-shaped fixture, and the ring-shaped fixture is configured to fix the mixing cushion and be detached from or attached to the distribution plate or the discharge plate, so that the mixing cushion can be conveniently replaced simply by separating the ring-shaped fixture from the distribution plate when the mixing cushion is contaminated.

### DESCRIPTION OF DRAWINGS

FIG. 1 is a view showing a conventional cosmetic container.

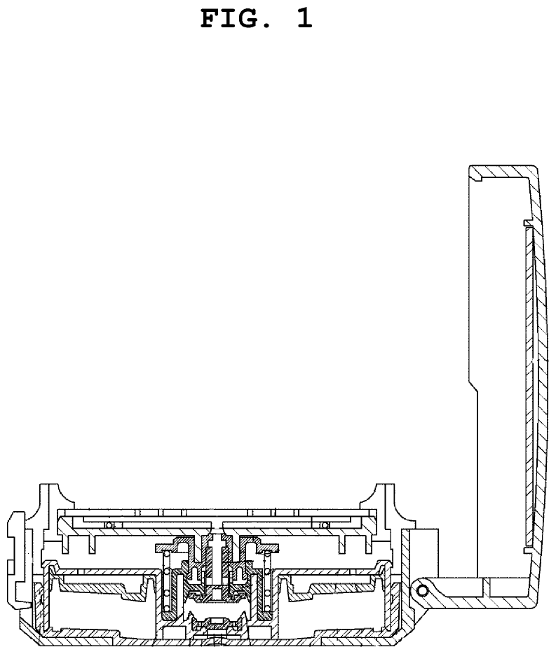

FIG. 2 is a view showing a conventional compact container.

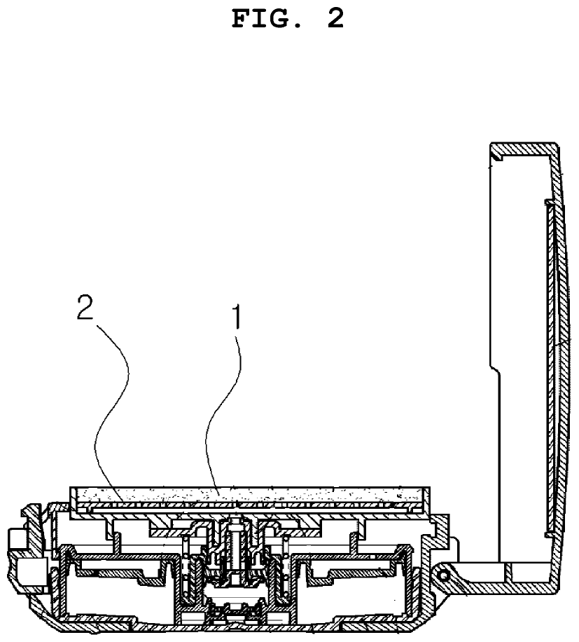

FIG. 3 is a perspective view showing a compact container having a mixing cushion and a mixing mesh according to the present invention.

FIG. 4 is an exploded perspective view showing a compact container having a mixing cushion and a mixing mesh according to the present invention.

FIG. 5 is a sectional view showing a compact container having a mixing cushion and a mixing mesh according to the present invention.

FIG. 6 is a sectional view showing a state of a cosmetic material discharged when a discharge plate of a compact container having a mixing cushion and a mixing mesh according to the present invention is pressed.

FIG. 7 is a sectional view showing a state of a cosmetic material introduced into a cylinder when a press of a discharge plate of a compact container having a mixing cushion and a mixing mesh according to the present invention is released.

FIG. 8 is a partial perspective view showing a state of a distribution plate, a mixing cushion and a ring-shaped fixture which are coupled to a discharge plate of a compact container having a mixing cushion and a mixing mesh according to the present invention.

### BEST MODE

### Mode for Invention

Hereinafter, an embodiment of the compact container having a mixing cushion and a mixing mesh according to the present invention will be described with reference to the accompanying drawings.

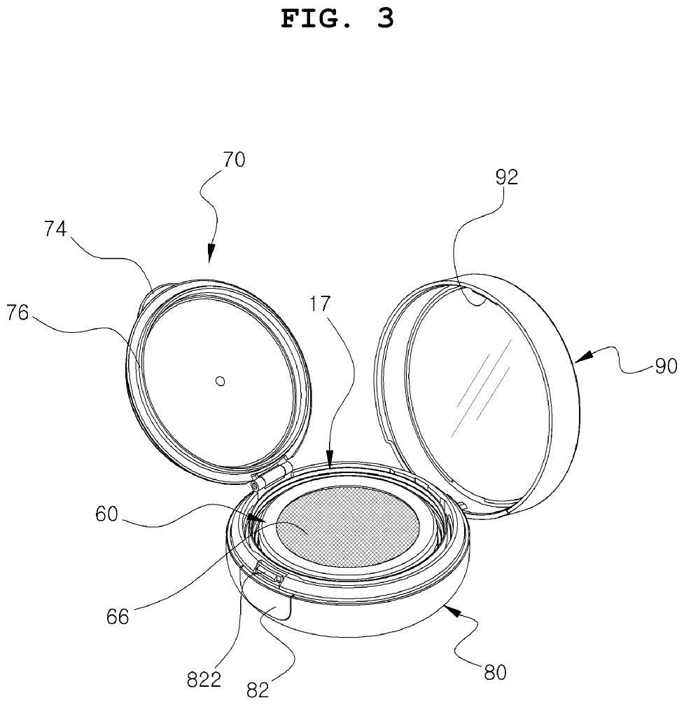

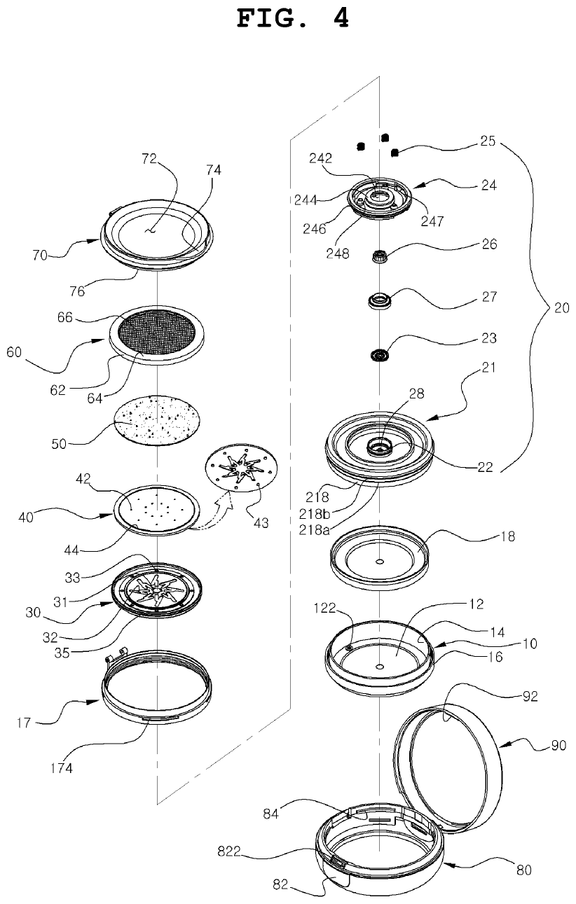

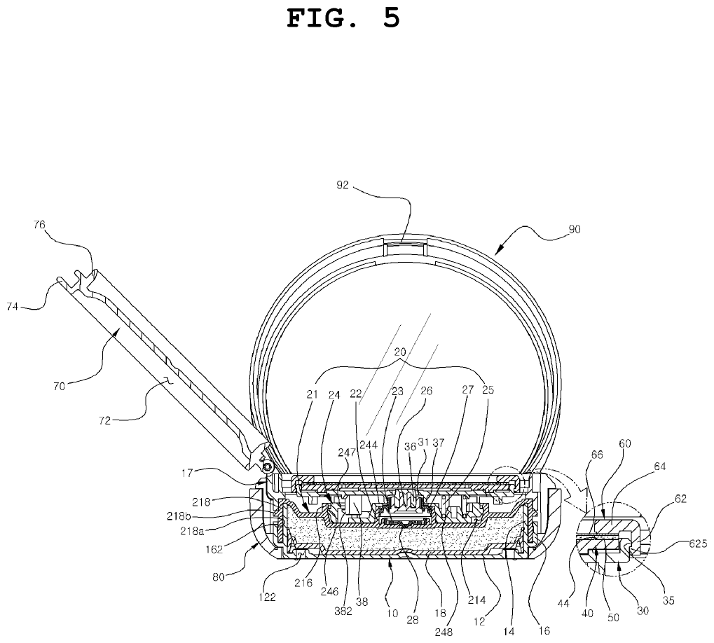

FIG. 3 is a perspective view showing a compact container having a mixing cushion and a mixing mesh according to the present invention. FIG. 4 is an exploded perspective view showing a compact container having a mixing cushion and a mixing mesh according to the present invention. FIG. 5 is a sectional view showing a compact container having a mixing cushion and a mixing mesh according to the present invention.

The compact container having a mixing cushion and a mixing mesh according to the present invention includes: an inner container 10 for containing a cosmetic material therein; a discharge device 20 for discharging the cosmetic material contained in the inner container 10; a distribution plate 30 for diffusing the cosmetic material discharged by the discharge device 20; a discharge plate 40 for discharging the cosmetic material diffused by the distribution plate 30 through an outlet 42; a mixing cushion 50 provided on the discharge plate 40 to uniformly mix the cosmetic material; and a ring-shaped fixture 60 detachably coupled to the distribution plate 30 or the discharge plate 40 while surrounding the mixing cushion 50, and provided at a center thereof with a mixing mesh 66.

A gel or liquid cosmetic material is contained inside the inner container 10, in which the inner container 10 includes an inner container bottom surface 12, an inner wall 14 upwardly extending from the inner container bottom surface 12, and an outer wall 16 outwardly spaced apart at a predetermined interval and upwardly extending from the inner wall 14.

An air flow hole 122 for introducing external air is formed in the inner container bottom surface 12 of the inner container 10.

A coupling groove 162 is formed on an inner periphery of the outer wall 16 of the inner container 10, and coupled to a pump housing 21.

The inner container 10 is formed therein with a lifting plate 18 for upwardly lifting the cosmetic material, and the lifting plate 18 comes into close contact with an inner side surface of the inner container 10.

The inner container 10 is coupled at an outer side thereof with an outer container 80 and an outer container lid 90 for opening/closing the outer container 80.

The outer container 80 is provided at a front thereof with a button 82, in which a latching protrusion 822 retracted by a press action of the user protrudes from an upper portion of the button 82.

An inner container coupling shoulder 17 for pressing and fixing the pump housing 21 of the discharge device 20 is coupled to the inside of the outer container 80, in which a first mount protrusion 84 is formed on an outer periphery of the outer container 80, a second mount protrusion 174 is formed on an outer periphery of the outer container coupling shoulder 17, and the first and second mount protrusions are undercut-coupled to each other.

The inner container coupling shoulder 17 has one side hinged to a shoulder lid 70 for opening/closing the inner container coupling shoulder 17.

The outer container lid 90 is hinged to one side of the outer container 80 to open/close the outer container 80.

A protrusion-shaped hook 92 is formed on one side of the outer container lid 90 at a position corresponding to the latching protrusion 822 of the outer container 80, and fastened to the latching protrusion 822 of the outer container 80.

The discharge device 20 is coupled to an upper portion of the inner container 10, such that the cosmetic material contained in the inner container 10 is discharged to the outside.

The discharge device 20 may be a pump for pumping and discharging the cosmetic material contained in the inner container 10 to the outside.

The discharge device 20 may include a pump housing 21 coupled to the upper portion of the inner container 10, a cylinder 22 provided at a center of the pump housing 21 and formed in a bottom surface thereof with a contents suction hole 28, a suction valve plate 23 mounted on the bottom surface of the cylinder 22 to selectively open/close the contents suction hole 28, a bushing 24 laid on an upper end of the cylinder 22 and coupled to an outer side of the cylinder 22, an elastic member 25 mounted on the bushing 24 to elastically support the distribution plate 30, a piston 26 provided inside the cylinder 22 and moved up and down, and a piston ring 27 fitted to an outer side of the piston 26 and coming into close contact with an inner side surface of the cylinder 22.

The pump housing 21 is coupled to the upper portion of the inner container 10 to serve to seal the inner container 10, and the pump housing 21 is formed at a center thereof with the cylinder 22, in which the cylinder 22 is formed at an outer side thereof with a bushing installation space 214 to which the bushing 24 is installed.

A first fastening protrusion wheel 216 is formed on an outer side of the bushing installation space 214, and a second fastening protrusion wheel 246 is formed on an outer periphery of the bushing 24 and undercut-coupled to the first fastening protrusion wheel 216.

A lower extension protrusion wheel 218 extends downward from an outer side of the pump housing 21, and a coupling protrusion 218a is formed on an outer periphery of the lower extension protrusion wheel 218 and coupled to the coupling groove 162 of the inner container 10, in which a fixing protrusion wheel 218b pressed by the inner container coupling shoulder 17 protrudes from an upper side of the coupling protrusion 218a.

A through hole 242 through which the piston 26 and the piston ring 27 pass is formed at a center of the bushing 24, an inner horizontal extension piece 244 extends inside the through hole 242, and a plurality of elastic member mounting parts 248 are formed on an outer side of the through hole 242.

A first latching sill 247 is formed on an upper inside of the bushing 24 to prevent the distribution plate 30 from being separated from the compact container.

The distribution plate 30 is coupled to the upper portion of the discharge device 20, presses the discharge device 20 while being moved upward and downward, and widely spreads the cosmetic material discharged by the discharge device 20.

The distribution plate 30 is formed at a center thereof with a discharge passage 31 through which the cosmetic material discharged by the discharge device 20 passes, a diffusion space 32 is formed at an outer side the discharge passage 31 to widely spread the cosmetic material having passed through the discharge passage 31, and an assembling groove 33 is formed at an outer side of the diffusion space 32.

A first lower extension protrusion wheel 36 is formed at a lower portion of the distribution plate 30, in which the first lower extension protrusion wheel 36 is coupled to the piston 26 of the discharge device 20.

A second lower extension protrusion wheel 37 is spaced apart from the first lower extension protrusion wheel 36 outward by a predetermined distance and extends downward, in which the second lower extension protrusion wheel 37 is fitted to an outer side of the piston ring 27 of the discharge device 20.

The second lower extension protrusion wheel 37 is formed at an outer side thereof with a separation preventing part 38 to prevent the distribution plate 30 from being separated from the compact container, in which a second latching sill 382 is formed under the separation preventing part 38 and fastened to the first latching sill 247 of the bushing 24.

The discharge plate 40 is coupled to an upper portion of the distribution plate 30, and discharges the cosmetic material diffused by the distribution plate 30 through an outlet 42.

The outlet 42 of the discharge plate 40 is formed radially at a position corresponding to the diffusion space 32 of the distribution plate 30.

The discharge plate 40 may be formed on an upper surface thereof with a movement preventing protrusion wheel for preventing the mixing cushion 50 mounted on the discharge plate 40 from moving.

In other words, since the mixing cushion 50 is laid on an upper portion of the discharge plate 40, when the user presses or rubs the mixing mesh 66 surrounding the mixing cushion 50 by using the puff P, the mixing cushion 50 may be moved. To prevent this, the movement preventing protrusion wheel 44 protrudes from the upper surface of the discharge plate 40 to fix a lower surface of the mixing cushion 50.

An assembling protrusion 43 is formed on a lower portion of the discharge plate 40, and the assembly protrusion 43 is fitted into the assembly groove 33 of the distribution plate 30, so that the discharge plate 40 is prevented from idling with respect to the distribution plate 30.

The mixing cushion 50 is mounted on the upper portion of the discharge plate 40 to serve to uniformly mix the cosmetic material discharged by the discharge device 20.

The mixing cushion 50 may be formed of at least one material selected from the group including butadiene rubber BR, styrene butadiene rubber SBR, natural rubber NR, wet urethane, dry urethane, polyether, polyester, polyvinyl chloride, polyethylene, ethylene vinyl acetate, latex, silicone, polystyrene polyisoprene polystyrene, polystyrene polyethylene butylene polystyrene, polyvinyl alcohol PVA, silicone elastomer, nitrile rubber, butyl rubber, and neoprene.

The mixing mesh 66 is provided at a center of the ring-shaped fixture 60, and the ring-shaped fixture 60 is detachably coupled to the distribution plate 30 or the discharge plate 40 while surrounding the mixing cushion 50.

In other words, when the user presses the mixing mesh 66 by using the puff P, the cosmetic material discharged by the discharge device 20 is absorbed into the mixing cushion 50, uniformly mixed, discharged through the mixing mesh 66, and uniformly applied onto the entire lower surface of the puff P, so that the user easily uses the uniformly mixed cosmetic material.

The ring-shaped fixture 60 includes a coupling part 62 detachably coupled to the distribution plate 30 or the discharge plate 40, and a joining part 64 extending inside the coupling part 62 and joined to the mixing mesh 66.

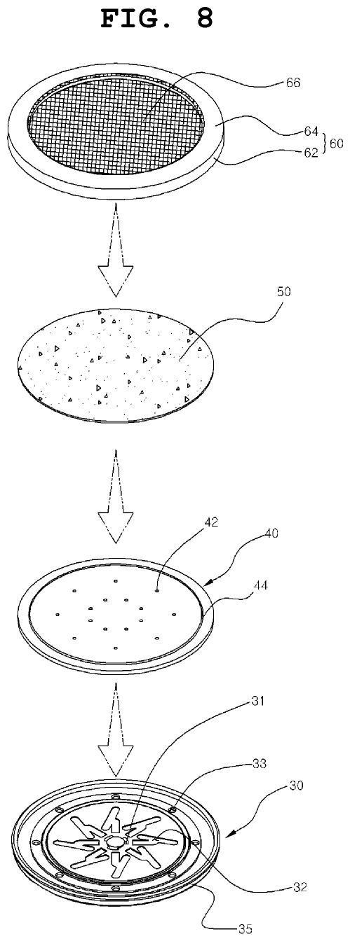

FIG. 8 is a partial perspective view showing a state of a distribution plate, a mixing cushion and a ring-shaped fixture which are coupled to a discharge plate of a compact container having a mixing cushion and a mixing mesh according to the present invention.

A first detachable protrusion 625 is formed on an inner periphery of the joining part 62, a second detachable protrusion 35 is formed on an outer periphery of the distribution plate 30, and the first and second detachable protrusions may be undercut-coupled to each other.

Referring to the coupling structure of the distribution plate 30, the discharge plate 40, the mixing cushion 50, and the ring-shaped fixture 60 in more detail, as shown in FIG. 8, first, after the discharge plate 40 is inserted to the upper portion of the distribution plate 30, the mixing cushion 50 is mounted on the upper surface of the discharge plate 40, the upper portion of the mixing cushion 50 is surrounded with the mixing mesh 66 joined to the ring-shaped fixture 60, and simultaneously the ring-shaped fixture 60 is detachably coupled to the distribution plate 30 or the discharge plate 40.

In other words, as described above, the ring-shaped fixture 60 fixes the mixing cushion 50 and simultaneously is detached from or attached to the distribution plate 30 or the discharge plate 40, so that the mixing cushion 50 may be conveniently replaced simply by separating the ring-shaped fixture 60 from the distribution plate 30 when the mixing cushion 50 is contaminated, and the mixing mesh 66 of the ring-shaped fixture 60 may be washed by water or detergent and reused.

The joining part 64 serves to press and fix the upper surface of the mixing cushion 50 when the ring-shaped fixture 60 is coupled to the distribution plate 30 or the discharge plate 40.

The mixing mesh 66 is joined to the lower surface of the joining part 64, in which the mixing mesh 66 may be joined to the joining part 64 by ultrasonic bonding, high frequency bonding, heat bonding, or an adhesive.

The shoulder lid 70 is hinged to one side of the inner container coupling shoulder 17 and opened and closed to prevent the mixing cushion 50 from being exposed to the outside and causing the mixing cushion 50 to be contaminated or moisture to be evaporated.

A puff accommodation space 72 is formed in an upper portion of the shoulder lid 70, and a handle 74 may be provided on one side of the shoulder lid 70 so that the user easily holds the shoulder lid 70.

A sealing protrusion wheel 76 extends downward from a lower side of the shoulder lid 70, and comes into close contact with an upper and inner periphery of the inner container coupling shoulder 17.

A method of assembling the compact container having a mixing cushion and a mixing mesh configured in the above manner will be described as follows with reference to the accompanying drawings.

In order to assemble the compact container having the mixing cushion and the mixing mesh according to the present invention, as shown in FIGS. 4 and 5, first, the inner container 10 is mounted to the inside of the outer container 80 having one side hinged to the outer container lid 90.

Next, the lifting plate 18 is fitted into the inner container 10, the cosmetic material is injected, and then the pump housing 21 of the discharge device 20 is coupled to the upper portion of the inner container 10, in which the lower extension protrusion wheel 218 of the pump housing 21 is inserted between an inner wall 14 and an outer wall 16 of the inner container 10 and simultaneously a coupling protrusion 218a of the lower extension protrusion wheel 218 is coupled to the coupling groove 162 of the inner container 10.

Next, the suction valve plate 23, bushing 24, elastic member 25, piston 26 and piston ring 27 are provided on the upper portion of the pump housing 21, and the distribution plate 30 is coupled to the upper portion of the discharge device 20, in which the second latching sill 382 formed on the separation preventing part 38 of the distribution plate 30 is fastened to the first latching sill 247 formed on the bushing 24 of the discharge device 20.

At the same time, the first lower extension protrusion wheel 36 and the second lower extension protrusion wheel 37 of the distribution plate 30 are coupled to the piston 26 and the piston ring 27 of the discharge device 20, respectively.

Next, the inner container coupling shoulder 17 having one side hinged to the shoulder lid 70 is coupled to the inside of the outer container 80, in which, while the inner container coupling shoulder 17 pushes and fixes the upper portion of the pump housing 21, the second mount protrusion 174 of the inner container coupling shoulder 17 is coupled to the first mount protrusion 84 of the outer container 80.

Next, as shown in FIG. 8, after the discharge plate 40 is coupled to the upper portion of the distribution plate 30, the mixing cushion 50 is mounted on the discharge plate 40.

Finally, while the upper portion of the mixing cushion is surrounded with the mixing mesh 66 joined to the ring-shaped fixture 60, the ring-shaped fixture 60 is detachably coupled to the distribution plate 30 or the discharge plate 40, in which the first detachable protrusion 625 of the ring-shaped fixture 60 is coupled to the second detachable protrusion 35 of the distribution plate 30. Thus, the assembly of the compact container having the mixing cushion and the mixing mesh according to the present invention is completed.

A method of using the compact container having a mixing cushion and a mixing mesh assembled as above will be described with reference to the accompanying drawings.

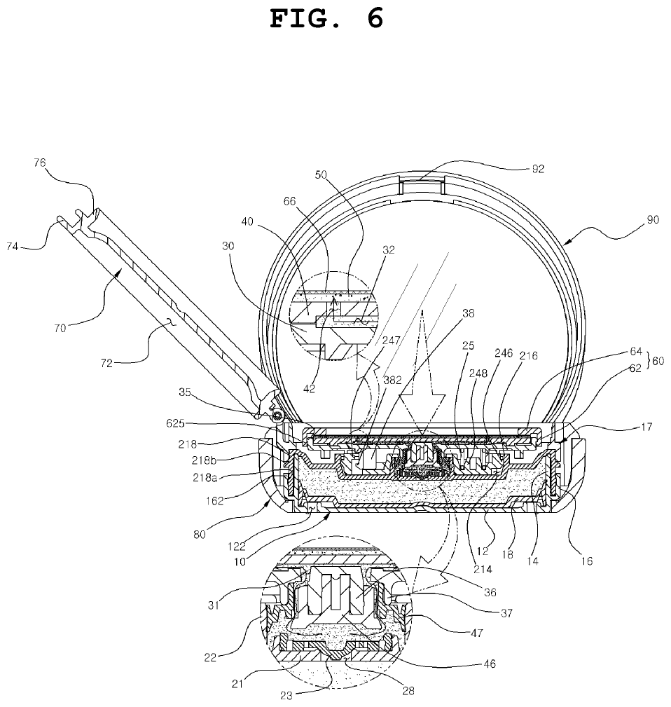

FIG. 6 is a sectional view showing a state of a cosmetic material discharged when a discharge plate of a compact container having a mixing cushion and a mixing mesh according to the present invention is pressed.

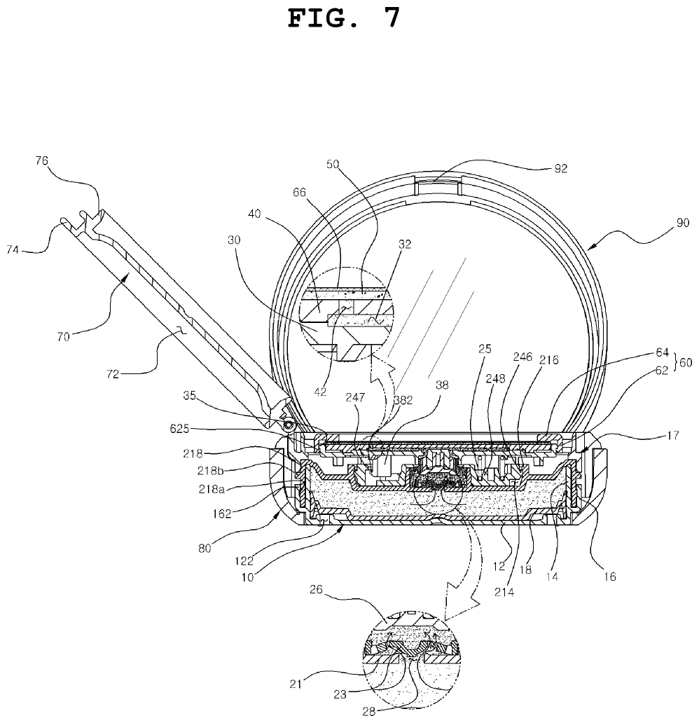

FIG. 7 is a sectional view showing a state of a cosmetic material introduced into a cylinder when a press of a discharge plate of a compact container having a mixing cushion and a mixing mesh according to the present invention is released.

In order to use the compact container having the mixing cushion and the mixing mesh according to the present invention, first, as shown in FIG. 6, the mixing mesh 66 and the mixing cushion 50 are pressurized by using a makeup tool such as the puff P.

When the mixing mesh 66 and the mixing cushion 50 are pressurized, the discharge plate 40 and the distribution plate 30 disposed below the mixing cushion 50 are also moved downward, and simultaneously the piston 26 of the discharge device 20 coupled to the lower side of the distribution plate 30 and the piston ring 27 are also moved downward, so that the volume inside the cylinder 22 is reduced.

Accordingly, a pressure is generated inside the cylinder 22, and the discharge pressure is generated as the cosmetic material in the cylinder 22 tends to be discharged to the outside due to the pressure, so that the suction valve plate 23 closes the contents suction hole 28 formed on the bottom surface of the cylinder 22.

At the same time, as shown in the enlarged view of FIG. 6, the cosmetic material contained in the cylinder 22 is discharged between the piston 26 and the piston ring 27, passes through the distribution passage 31 of the distribution plate 30 and the diffusion space 32 of the distribution plate 30, and is discharged to the outlets 42 of the discharge plate 40.

Then, the discharged cosmetic material is absorbed in the mixing cushion 50, uniformly mixed, discharged through the mixing mesh 66, and then uniformly applied onto the entire lower surface of the puff.

Then, as shown in FIG. 7, when the pressurization of the mixing mesh 66 and the mixing cushion 50 is released, the distribution plate 30 is moved upward by the elasticity of the elastic member 25 for elastically supporting the distribution plate 30, and the piston 26 and the piston ring 27 coupled to the lower side of the distribution plate 30 are also moved upward, so that the volume inside the cylinder 22 is increased, thereby generating a vacuum pressure.

At the same time, the suction valve plate 23 is lifted by the vacuum pressure generated in the cylinder 22, thereby opening the contents suction hole 28 formed on the bottom surface of the cylinder 22, accordingly, the cosmetic material contained in the inner container 10 is introduced into the cylinder 22 through the contents suction hole 28, and simultaneously the lifting plate 18 installed inside the inner container 10 is moved upward.

In addition, when the contaminated mixing cushion 50 is replaced with a new mixing cushion 50 upon contamination of the mixing cushion 50, the ring-shaped fixture 60 is separated from the distribution plate 30, and then the contaminated mixing cushion 50 is removed.

Then, as shown in FIG. 8, the new mixing cushion 50 is placed on the upper surface of the discharge plate 40, the mixing mesh 66 joined to the ring-shaped fixture 60 is washed by water or detergent and dried, and the ring-shaped fixture 60 is coupled to the distribution plate 30 or the discharge plate 40, in which the ring-shaped fixture 60 is coupled to the distribution plate 30 or the discharge plate 40 while the upper portion of the mixing cushion 50 being surrounded with the mixing mesh 66 joined to the ring-shaped fixture 60. Thus, the replacement of the mixing cushion 50 of the compact container having the mixing cushion and the mixing mesh according to the present invention is completed.

The present invention described in the above is merely one embodiment for carrying out the compact container having a mixing cushion and a mixing mesh, and the present invention is not limited to the embodiment.

preferable embodiments have been proposed and set forth in the aforementioned description, however the present invention should not be construed as limited thereto, and it will be apparent to those having ordinary skill in the art in that many different substitutions, deformations and modifications are available within the scope without departing from the invention.

[Description of Reference Numerals]

10: inner container
17: inner container coupling shoulder
20: discharge device
21: pump housing
30: distribution plate
31: discharge passage
32: diffusion space
40: discharge plate
42: outlet
44: movement preventing protrusion wheel
50: mixing cushion
60: ring-shaped fixture
62: coupling part
64: joining part
66: mixing mesh
70: shoulder lid
80: outer container
90: outer container lid

1. A compact container having a mixing cushion and a mixing mesh, the compact container comprising:
an inner container (10) for containing a cosmetic material therein;
a discharge device (20) for discharging the cosmetic material contained in the inner container (10);
a distribution plate (30) for diffusing the cosmetic material discharged by the discharge device (20);
a discharge plate (40) for discharging the cosmetic material diffused by the distribution plate (30) through an outlet (42);
a mixing cushion (50) provided on the discharge plate (40) to uniformly mix the cosmetic material; and
a ring-shaped fixture (60) detachably coupled to the distribution plate (30) or the discharge plate (40) while surrounding the mixing cushion (50), and provided at a center thereof with a mixing mesh (66).

2. The compact container of claim 1, wherein an inner container coupling shoulder (17) is provided at an outer periphery of a pump housing (21) of the discharge device (20), and a shoulder lid (70) for opening and closing the inner container coupling shoulder (17) is coupled to one side of the inner container coupling shoulder (17).

3. The compact container of claim 1, wherein the discharge device (20) includes a pump for pumping and discharging the cosmetic material to an outside.

4. The compact container of claim 1, wherein the discharge plate (40) is formed on an upper surface thereof with a movement preventing protrusion wheel (44) for preventing the mixing cushion (50) from moving.

5. The compact container of claim 1, wherein the ring-shaped fixture (60) comprises: a coupling part (62) detachably coupled to the distribution plate (30) or the discharge plate (40); and a joining part (64) extending inward of the coupling part (62) and joined to the mixing mesh (66).
